(19) United States
(12) Patent Application Publication
(10) Pub. No.: US 2023/0305727 A1
(43) Pub. Date: Sep. 28, 2023

(54) MIGRATION OF PRIMARY AND SECONDARY STORAGE SYSTEMS

(71) Applicant: International Business Machines Corporation, Armonk, NY (US)

(72) Inventors: David R. Blea, Round Rock, TX (US); William J. Rooney, Hopewell Junction, NY (US)

(21) Appl. No.: 17/655,804

(22) Filed: Mar. 22, 2022

(51) Int. Cl. G06F 3/06

(52) U.S. Cl. CPC G06F 3/0647; G06F 3/0604; G06F 3/0689

(57) ABSTRACT

Provided is a method for migrating from a first storage system to a second storage system. The method includes receiving a command to migrate from a first storage system to a second storage system, wherein the first storage system comprises a first primary storage and a first secondary storage, and wherein the second storage system comprises a second primary storage and a second secondary storage. The method further includes initiating, in response to receiving the command, data replication between the first primary storage and the second primary storage. The method further includes initiating, in response to receiving the command, data replication between the first primary storage and the second secondary storage. The method further includes migrating from the first storage system to the second storage system.

### BACKGROUND

The present disclosure relates generally to the field of computer storage systems, and more particularly to migrating data to a replacement storage device using a multi-storage volume swap.

Data backup systems can provide continuous availability of production data in the event of a sudden catastrophic failure at a single point in time or data loss over a period of time. In one such disaster recovery system, production data is replicated from a local site to a remote which may be separated geographically by several miles from the local site. Such dual, mirror or shadow copies are typically made in a secondary storage device at the remote site, as the application system is writing new data to a primary storage device usually located at the local site. Different data replication technologies may be used for maintaining remote copies of data at a secondary site, such as IBM® Metro Mirror Peer to Peer Remote Copy (PPRC), Extended Remote Copy (XRC), Coupled XRC (CXRC), Global Copy, and Global Mirror Copy.

### SUMMARY

Embodiments of the present disclosure include a method, computer program product, and system for migrating from a first storage system to a second storage system. The method includes receiving a command to migrate from a first storage system to a second storage system, wherein the first storage system comprises a first primary storage and a first secondary storage, and wherein the second storage system comprises a second primary storage and a second secondary storage. The method further includes initiating, in response to receiving the command, data replication between the first primary storage and the second primary storage. The method further includes initiating, in response to receiving the command, data replication between the first primary storage and the second secondary storage. The method further includes migrating from the first storage system to the second storage system.

This approach may provide numerous advantages over current migration processes. For example, embodiments of the present disclosure provide the ability to migrate without losing high availability with the multi-storage volume swapping capability that is possible using a software-based data migration product, but while reducing or eliminating the additional CPU utilization inherent in a software-based mirroring solution. Reducing the CPU utilization can result in lower software licensing costs and/or lower impact to business critical work if the CPU capacity is not increased. Embodiments also reduce the amount of time necessary to perform the migration swap when compared to existing solutions. Furthermore, embodiments of the present disclosure are flexible and can be used with any copy services management tool, such as those provided by EMC (e.g., Geographically Dispersed Disaster Restart (GDDR), Symmetrix Remote Data Facility (SRDF), and AutoSwap) and Hitachi (e.g., Hitachi Universal Replicator (HUR)). Embodiments of the present disclosure may additionally be substantially automated, whereas prior migration processes and operations frequently involve significant manual intervention, which are often time consuming, error prone, and could potentially result in some data loss.

In some preferred embodiments, the second storage system may be prepared for migration prior to migrating from the first storage system to the second storage system. Preparing the second storage system may comprise converting a replication mode between the first primary storage and the second primary storage to synchronous and converting a replication mode between the first primary storage and the second secondary storage to synchronous. This may advantageously allow the replication to initially be in asynchronous mode while the bulk of the data is being replicated, with the mode being switched to synchronous shortly before migration. Because asynchronous mode is less resource intensive (e.g., since fewer write operations are performed at the same time), this reduces the impact that the migration has on application performance. In addition, using asynchronous mode allows application I/O requests to complete without waiting for data to be sent to the target storage and the subsequent acknowledgement that the copy is complete, inherent to synchronous mirroring, which might otherwise add additional delay to the I/O request. Although one might expect all three synchronous I/O requests to complete simultaneously, reasons exist such that that may not be the case, such as congestion, link failure, etc., and as such, waiting to switch provides better application performance.

In some preferred embodiments, multi-storage volume swapping is enabled between the first primary storage and the second primary storage. The multi-storage volume swapping may be enabled once full duplex status has been reached between the first primary storage and both the second primary storage and the second secondary storage. Advantageously, enabling multi-storage volume swapping between the first primary storage and the second primary storage may allow the system to failover to the second primary storage instead of to the first secondary storage in the event that an error accessing the first primary storage occurs during migration.

Further embodiments of the present disclosure include a method, computer program product, and system for migrating from a first storage system to a second storage system. The method includes receiving a command to migrate from a first storage system to a second storage system. The first storage system comprises a first primary storage and a first secondary storage, and the second storage system comprises a second primary storage and a second secondary storage. The method further includes replicating, in response to receiving the command, data between the first primary storage and the second primary storage. The method further includes replicating, in response to receiving the command, data between the first primary storage and the second secondary storage. The method further includes, in response to full duplex status being reached between the first primary storage and both the second primary storage and the second secondary storage, suspending I/O operations received for executing on the first storage system, storing the I/O operations in a queue, and enabling multi-storage volume swapping between the second primary storage and the second secondary storage. The method further includes migrating from the first storage system to the second storage system such that new received I/O operations are executed on the second storage system. The method further includes resuming I/O operations and executing the queued I/O operations on the second storage system.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a diagram of an example data migration process.

FIG. 2 illustrates an example network computing environment employing a primary storage system and a secondary storage system, in accordance with embodiments of the present disclosure.

FIG. 3A illustrates an example block diagram depicting a storage state prior to migration of the old primary and secondary storage systems to new primary and secondary storage systems, in accordance with embodiments of the present disclosure.

FIG. 3B illustrates an example block diagram depicting a storage state during migration of the old primary and secondary storage systems to new primary and secondary storage systems, in accordance with embodiments of the present disclosure.

FIG. 3C illustrates an example block diagram depicting a storage state following migration of the old primary and secondary storage systems to new primary and secondary storage systems, in accordance with embodiments of the present disclosure.

FIG. 4 illustrates a flowchart of an example method for migrating from old storage systems to new storage systems using a multi-storage volume swap, in accordance with embodiments of the present disclosure.

FIG. 5 illustrates a flowchart of an example method for migrating data from the old storage systems to the new storage systems, in accordance with embodiments of the present disclosure.

FIG. 6 illustrates a high-level block diagram of an example computer system that may be used in implementing one or more of the methods, tools, and modules, and any related functions, described herein, in accordance with embodiments of the present disclosure.

FIG. 7 depicts a cloud computing environment, in accordance with embodiments of the present disclosure.

FIG. 8 depicts abstraction model layers, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate generally to the field of computer storage systems, and in particular to migrating data to a replacement storage device using a multi-storage volume swap. While the present disclosure is not necessarily limited to such applications, various aspects of the disclosure may be appreciated through a discussion of various examples using this context.

For the sake of illustration only, embodiments of the present disclosure are described herein with reference to IBM® Copy Services Manager (CSM) and IBM® HyperSwap®. However, embodiments of the present invention are not limited to either of these technologies, and all suitable alternatives (i.e., those with similar functionalities of import) are contemplated.

In data mirroring systems, data is typically maintained in volume pairs, comprising a primary volume in a primary storage device and a corresponding secondary volume in a secondary storage device that includes an identical copy of the data maintained in the primary volume. The primary and secondary volumes are identified by a copy relationship in which the data of the primary volume, also referred to as the source volume, is copied to the secondary volume, also referred to as the target volume. Primary and secondary storage controllers may be used to control access to the primary and secondary storage devices.

IBM® Copy Services Manager (CSM) is an example of an application that customers may use to manage planned and unplanned outages. Solutions that include CSM can detect failures at the primary storage system which may be at a local site, for example. Such failures may include a problem writing or accessing primary storage volumes at the local site. When the solution detects that a failure has occurred, the CSM can invoke a multi-storage volume swapping function, an example of which is the IBM HyperSwap® function (e.g., logical device swapping). This function may be used to automatically swap processing for all volumes in the mirrored configuration from the primary storage system to the secondary storage system (e.g., which may include swapping from a local site to a remote site, in some embodiments). In some embodiments, the CSM can initiate a swap even when no failure is detected. As a consequence of the swap, the storage volumes at the remote site which were originally configured as the secondary volumes of the original copy relationship, are reconfigured as the primary volumes of a new copy relationship. Similarly, the storage volumes at the local site which were originally configured as the primary volumes of the original copy relationship, may be reconfigured as the secondary volumes of the new copy relationship, once the volumes at the local site are operational again.

In connection with the swapping function, a failover function may be invoked. In the case of a solution that includes CSM, the failover function can, in some instances, obviate performing a full copy when re-establishing data replication in the opposite direction, that is, from the remote site back to the local site. More specifically, the failover processing resets or reconfigures the remote storage devices (which were originally configured as the secondary storage devices) to be the primary storage devices which are placed in a “suspended” status pending resumption of the mirroring operation but in the opposite direction. In the meantime, the failover processing starts change recording for any subsequent data updates made by the host to the remote site.

Once the local site is operational, failback processing may be invoked to reset the storage devices at the local site (which were originally configured as the primary storage devices) to be the secondary storage devices. Mirroring may then be resumed (but in the opposite direction, that is remote to local rather than local to remote) to resynchronize the secondary storage devices (originally the primary storage devices) at the local site to the data updates being stored at the primary storage devices (originally the secondary storage devices) at the remote site. Once data synchronization is complete, the HyperSwap® return operation can reestablish management of the configuration from the storage systems at the local site, which were the original primary storage systems, to the storage systems at the remote, site which were the original secondary storage systems. With both mirroring and HyperSwap now reestablished in the reverse direction, the configuration can then remain in this configuration, where the remote storage devices remain the primary devices and the local devices remain the secondary devices, which is often the case if the remote storage devices are physically colocated. If it is desired, a planned HyperSwap may be initiated to return to the original configuration, following the steps above, but in the reverse direction and without the occurrence of a device failure. Of course, an unplanned HyperSwap, where a device failure was detected, would have the same result, moving the primary from the remote location back to the local location.

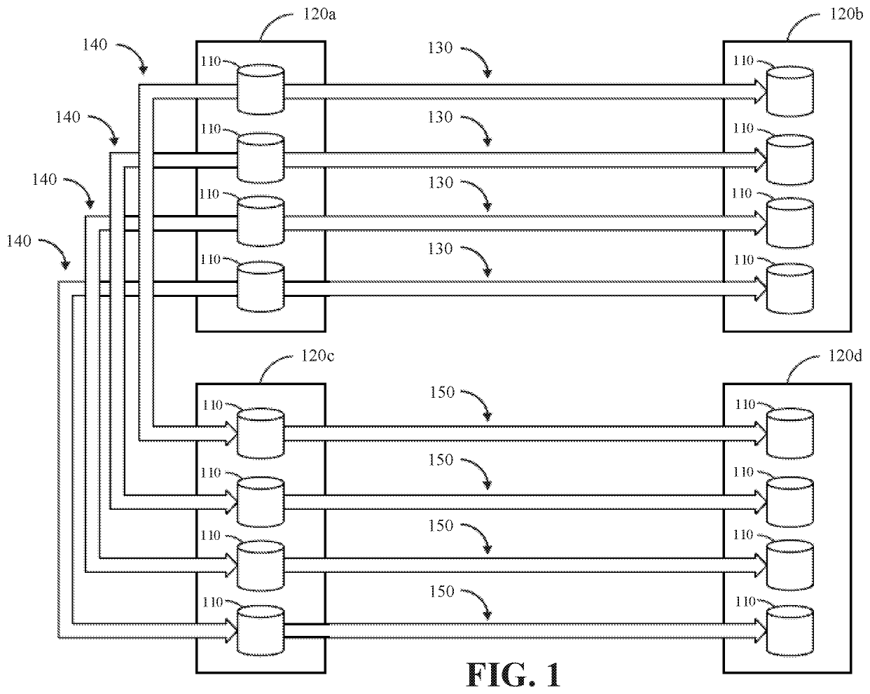

In various situations, it may be appropriate to switch one or more volumes of the primary or source storage to corresponding volumes of a different source storage without significantly impacting the users' production work. For example, the user may wish to migrate the source storage to a new storage system, or to a different storage system, in order to improve overall performance or for reconfiguration purposes. FIG. 1 shows an example of a typical data replication session in which data on volumes 110 of a first storage control unit 120a (i.e., the old primary storage) is being replicated on corresponding volumes 110 of a second data storage control unit 120b (i.e., the old secondary storage) in an ongoing data replication process represented by arrows 130. In addition, the data on the volumes 110 of the first storage control unit 120a is being migrated to corresponding volumes 110 of a third data storage control unit 120c (i.e., the new primary storage) in an ongoing data migration process represented by arrows 140.

Various products are available for migrating data from an existing storage system to a new storage system with little or no disruption to ongoing input/output (I/O) operations or to a disaster recovery capability which may be provided in case of a failure over the course of the data migration. Examples of such data migration products include TDMF (Transparent Data Migration Facility) by IBM Corporation or FDRPAS by Innovation Data Processing. However, if the volumes 110 of the storage control units 120a and 120b are part of an existing storage replication session such as the data replication process 130, for example, volumes 110 of a fourth control unit, such as storage control unit 120d (i.e., the new secondary storage), have typically been provided in order to assure that failover capability is maintained.

Thus, in a typical migration process in which data stored on volumes 110 of storage control unit 120a are migrated from storage control unit 120a to corresponding volumes 110 of the storage control unit 120c, a fourth storage control unit 120d is typically provided, and a data replication process as indicated by the arrows 150 is started before the migration process 140, to replicate the data which may initially be stored on the storage control unit 120c, to the storage control unit 120d. The initial portion of the data replication process 150 includes configuring the volumes 110 of the storage control unit 120d to correspond to the volumes 110 of the storage control unit 120c which in turn have been configured to correspond to the volumes 110 of the storage control unit 120a, the source of the data to be migrated.

Thus, the overall migration process typically includes a wait for the two new storage control units 120c and 120d to reach full duplex status, that is, the configurations of the storage volumes 110 of the storage control unit 120c having copy relationships of the storage control units 120c and 120d, have been replicated in the volumes 110 of the storage control unit 120d, and the data on those configured volumes 110 are identical to the initial data stored on the storage control unit 120c. At this point of the overall process, the migration process 140 is typically started using a migration product such as TDMF or FDRPAS, for example. The migration product will start copying data from storage control unit 120a to storage control unit 120c. Once data migration product has copied most of the data from storage control unit 120a to storage control unit 120c, it quiesces I/O to storage control unit 120a, copies the remaining changes (data writes) to storage control unit 120a from storage control unit 120a to storage control unit 120c, and then swaps I/O requests to go to storage control unit 120c.

A data replication process such as the data replication process 130 may frequently involve many copy relationship pairs, often numbering in the thousands. Hence, in a typical data migration, a relatively smaller number of source volumes of the control unit 120a are selected at a time for migration to the new storage control unit 120c. Accordingly, the copy relationship pairs of those source volumes of the storage control unit 120a for migration are typically first added manually to the existing replication session represented by the process 150. The replication session process 150 is started (or restarted) and a wait is incurred until the added copy relationship pairs reach full duplex status in the replication process 150. Once full duplex status has been achieved for the added copy relationship pairs, the migration process 140 is started (or restarted) for the selected source volumes of the control unit 120a and another wait is typically incurred for the migration product to swap the selected volumes 110 from storage control unit 120a to the storage control unit 120c. Once that swap is complete, the selected copy relationship pairs for the volumes 110 in the storage control unit 120a and the storage control unit 120b are removed from the replication process 130 and their relationships terminated. This process is repeated until all source volumes of the storage control unit 120a to be migrated have been selected and processed as described above.

Data may also be migrated to a new storage system without using a data migration product such as such as TDMF or FDRPAS, for example. However, such data migration processes may result in interruptions to ongoing data replication processes or disaster recovery capabilities. One example of such a migration process may occur when a source storage device is being migrated to a new source device, but the target storage device is not changing.

In this example, the migration process may include selecting the source volumes 110 of the storage control unit 120a to be migrated to the new storage control unit 120c and first manually removing, from the replication process 130, the copy relationship pairs for the selected volumes 110 in storage control unit 120a and the corresponding volumes 110 of the storage control unit 120b and terminating those relationship pairs. New copy relationship pairs corresponding to the terminated copy relationship pairs may then be manually established between the new source volumes 110 in the storage control unit 120c and the original target volumes 110 in the storage control unit 120b.

Alternatively, if the goal is to migrate to a new generation of storage system for both the primary and secondary storage system(s) using CSM and HyperSwap, while maintaining disaster recovery capability and high availability, the user can go through a multi-step process where first the primary storage system is replaced and then this is repeated for the secondary storage system. However, this process can be slow since it requires that all of the steps for migrating the secondary storage system be performed after the primary storage system is fully migrated, making the operations highly sequential.

Embodiments of the present disclosure provide a way to migrate data from one set of source (i.e., primary) and target (i.e., secondary) volumes to another set while maintaining disaster recovery capability throughout the data migration and without requiring that the process be performed twice. This is done by extending the multi-target support of some storage systems (e.g., as found in the IBM® System Storage® D58000® series) to support at least three targets. Then, that extended capability is used to allow the primary volumes to be mirrored not only to the old secondary and the new primary volumes, but also to the new secondary volumes. By doing this, the global copy role pair between the new primary storage and the new secondary storage can be replaced by a metro mirror role pair between the old primary storage and the new secondary storage.

In some embodiments, a system may migrate from a first pair of storage devices (e.g., an old primary storage device and an old secondary storage device) to a second pair of storage devices (e.g., a new primary storage device and a new secondary storage device). This may be done, for example, if a user is upgrading to a new storage solution to, for example, improve the performance, capacity, functionality (or capabilities) of the storage. In a first operation, data stored in the old primary storage unit is mirrored from the old primary storage unit to a new primary storage unit and to a new secondary storage unit. Software for performing the mirroring operation may include a suitable copy services management tool, such as those provided by EMC (e.g. Geographically Dispersed Disaster Restart (GDDR), Symmetrix Remote Data Facility (SRDF), and AutoSwap), Hitachi (e.g. Hitachi Universal Replicator (HUR)), or IBM (e.g. IBM® Copy Services Manager (CSM)). Such a tool may be utilized by a storage manager in accordance with the present description which can facilitate a migration of data as described herein. After the data has been mirrored to the new primary and secondary storage units, a failover operation may be performed so that new I/O requests are directed to the new primary storage unit.

This approach provides numerous advantages over current migration processes. For example, embodiments of the present disclosure provide the ability to migrate without losing high availability with the multi-storage volume swapping (e.g., HyperSwap) capability that is possible using a software-based data migration product such as TDMF or FDRPAS, but while reducing or eliminating the additional CPU utilization inherent in a software-based mirroring solution. Reducing the CPU utilization can result in lower software licensing costs and/or lower impact to business critical work if the CPU capacity is not increased. Embodiments also provide the ability to minimize the time necessary to perform the migration swap when compared to existing solutions. Furthermore, embodiments of the present disclosure are flexible and can be used with any copy services management tool, such as those provided by EMC (e.g., Geographically Dispersed Disaster Restart (GDDR), Symmetrix Remote Data Facility (SRDF), and AutoSwap) and Hitachi (e.g., Hitachi Universal Replicator (HUR)).

In yet another aspect, many of the operations of a migration process in accordance with the present disclosure may be automated. For example, operations such as terminating copy relationship pairs in the original source and target storage subsystems and reestablishing them in the replacement source and target storage subsystems can be done automatically. As explained in greater detail below, such automation may be provided in a multi-storage volume swap function. In contrast, it is appreciated that prior migration processes and operations frequently involve significant manual intervention, which are often time consuming, error prone, and could potentially result in some data loss.

It is to be understood that the aforementioned advantages are example advantages and should not be construed as limiting. Embodiments of the present disclosure can contain all, some, or none of the aforementioned advantages while remaining within the spirit and scope of the present disclosure.

Although the embodiments are described in connection with a specific mirror relationship, aspects of the present disclosure are applicable to other types of copy relationships, depending upon the particular application. Additional features are discussed in the present description. It is appreciated that still other features may be realized instead of or in addition to those discussed herein, depending upon the particular application.

In the illustrated embodiments, a copy relationship identifies a source storage location, also referred to as a primary storage location, and a target storage location, also referred to as a secondary storage location, in which data stored at the source storage location is to be mirrored or otherwise copied to the target storage location. Thus, as used herein, a primary storage location and a secondary storage location are storage locations related by a copy relationship.

Furthermore, as used herein, the term “storage location” refers to a storage location containing one or more units of data storage such as one or more volumes, cylinders, tracks, segments, extents, or any portion thereof, or other unit or units of data suitable for storage. Thus, a source storage location and the associated target storage location may each be a storage volume, wherein the volumes are typically at different devices or sites. However, it is appreciated that a source storage location and a target storage location may each be of a size other than a volume, for example.

As used herein, the term “automatically” includes both fully automatic, that is operations performed by one or more software controlled machines with no human intervention such as user inputs to a graphical user interface. As used herein, the term “automatically” further includes predominantly automatic, that is, most of the operations (such as greater than 50%, for example) are performed by one or more software controlled machines with no human intervention such as user inputs to a graphical user interface, and the remainder of the operations (less than 50%, for example) are performed manually, that is, the manual operations are performed by one or more software controlled machines with human intervention such as user inputs to a graphical user interface to direct the performance of the operations.

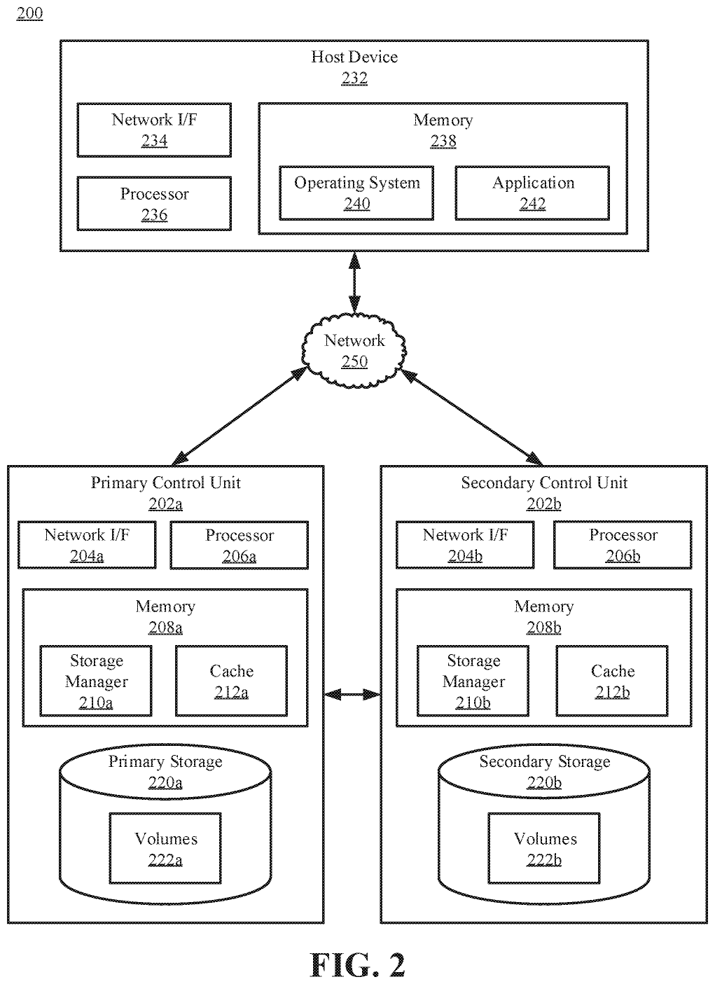

Turning now to the figures, FIG. 2 illustrates a block diagram of an example representation of a data storage environment 200 for storing host data. The data storage environment 200 includes a host device 232, a primary control unit 202a including a first (e.g., primary) storage 220a, and a secondary control unit 202b including to a second (e.g., secondary) storage 220b. The primary and secondary control units may be, for example, separate computer systems (e.g., servers, network-attached storage (NAS) devices, desktop computers, etc.), separate storage nodes, or components of a single device (e.g., individual components of a single storage node). The host device 232 is communicatively coupled with the primary and secondary control units 202a, 202b using a network 250. In some embodiments, data storage environment 200 may be embodied as storage-attached network (SAN).

Consistent with various embodiments, the host device 232 and the primary and secondary control units 202a, 202b may be computer systems. For example, in some embodiments, the host device 232 and the primary and secondary control units 202a, 202b may be storage server computers. The host device 232 includes a processor 236 and a memory 238. The memory 238 may include an operating system 240 and one or more applications 242 configured to utilize (e.g., access, read, write) data stored in the first and second storage 220a, 220b. Likewise, the primary and secondary control units 202a, 202b include one or more processors 206a, 206b and one or more memories 208a, 208b, respectively. The memories 208a, 208b of the primary and secondary control units 202a, 202b may include storage managers 210a, 210b and caches 212a, 212b.

The operating system 240 may include a multi-storage volume swap manager that provides a multi-storage volume swap function such as the IBM HyperSwap® function. As explained in greater detail below, a multi-storage volume swap function such as the IBM HyperSwap® may be modified in accordance with the present disclosure to facilitate a swap operation in connection with a migration operation to replace the primary and secondary storage systems with new storage systems. Although the multi-storage volume swap manager is a part of the operating system 240 of the host 232 in the illustrated embodiment, it is appreciated that a multi-storage volume swap manager may be implemented in application software of a host, or in the operating system or application software of a storage control unit, for example, for storage management functions.

The primary and secondary control units 202a, 202b and the host device 232 may be configured to communicate with each other through an internal or external network interface 204a, 204b, and 234. The network interfaces 204a, 204b, and 234 may be, e.g., modems or network interface cards. For example, the network interfaces 204a, 204b, and 234 may enable the host device 232 and the primary and secondary control units 202a, 202b to connect to the network 250 and communicate with each other.

The first storage 220a and second storage 220b illustrate data storage nodes in the data storage environment 200. In some embodiments, the first storage 220a includes a first set of (i.e., one or more) volumes 222a where data is stored and/or retrieved by the host device 232. Similarly, the second storage 220b includes a second set of volumes 222b. The volumes 222a, 222b may include a Logical Unit Number (LUN), Logical Subsystem (LSS), or any other grouping of tracks, where a track may be a block, track, or any other data unit. The data in second storage 220b (e.g., the second set of volumes 222b) may be a copy of the same data stored in the first storage 220a (e.g., a copy of the first set of volumes 222a). The host device 232 may access first and second volumes 222a, 222b in the first storage 220a and the second storage 220b, respectively, over the network 250.

The host device 232 may direct Input/Output (I/O) requests to the primary control unit 202a, which may function as a primary storage device, to access tracks stored in the first storage 220a. The secondary control unit 202b may function as a secondary, or backup, storage device in the event that the data could not be accessed via the first control unit 202a. The primary and secondary control units 202a, 202b may be in a synchronous mode such that and data written to the primary control unit 202a is simultaneously written to the secondary control unit 202b, thereby ensuring that both control units 202a, 202b have identical copies of the data at all times. This is referred to herein as the control units 202a, 202b (or, in some embodiments, individual storage 220 or volumes 222) having a mirror relationship or mirror copy relationship. In the event that the host device 232 (or the first control unit 202a) detects that the first set of volumes 222a are unavailable, a failover event may occur in which the secondary control unit 202b becomes the primary storage device, and a copy of the requested data (e.g., the data that was being read or written to) may be retrieved from corresponding tracks or volumes in the second set of volumes 222b.

The primary and secondary control units 202a, 202b and/or the host device 232 may be equipped with a display or monitor. Additionally, the primary and secondary control units 202a, 202b and/or the host device 232 may include optional input devices (e.g., a keyboard, mouse, scanner, or other input device), and/or any commercially available or custom software (e.g., browser software, communications software, server software, natural language processing software, search engine and/or web crawling software, filter modules for filtering content based upon predefined parameters, etc.).

The primary and secondary control units 202a, 202b and the host device 232 may be distant from each other and communicate over a network 250. In some embodiments, the host device 232 may be a central hub from which primary and secondary control units 202a, 202b can establish a communication connection, such as in a client-server networking model. Alternatively, the host device 232 and primary and secondary control units 202a, 202b may be configured in any other suitable networking relationship (e.g., in a peer-to-peer configuration or using any other network topology).

In some embodiments, the network 250 can be implemented using any number of any suitable communications media. For example, the network 250 may be a wide area network (WAN), a local area network (LAN), a storage area network (SAN), an internet, or an intranet. In certain embodiments, the primary and secondary control units 202a, 202b and the host device 232 may be local to each other, and communicate via any appropriate local communication medium. For example, the primary and secondary control units 202a, 202b and the host device 232 may communicate using a SAN, one or more hardwire connections, a switch such as a fibre channel switch or FICON director, a wireless link or router, or an intranet. In some embodiments, the primary and secondary control units 202a, 202b and the host device 232 may be communicatively coupled using a combination of one or more networks and/or one or more local connections. For example, the first control unit 202a may be hardwired to the host device 232 (e.g., connected with a fibre channel cable) while the second control unit 202b may communicate with the host device using the network 250 (e.g., over the Internet).

In some embodiments, the network 250 may be a telecommunication network. The telecommunication network may include one or more cellular communication towers, which may be a fixed-location transceiver that wirelessly communicates directly with a mobile communication terminal (e.g., primary and secondary control units 202a, 202b). Furthermore, the network may include one or more wireless communication links between the primary and secondary control units 202a, 202b and the host device 232. The wireless communications links may include, for example, shortwave, high frequency, ultra-high frequency, microwave, wireless fidelity (Wi-Fi), Bluetooth technology, global system for mobile communications (GSM), code division multiple access (CDMA), second-generation (2G), third-generation (3G), fourth-generation (4G), or any other wireless communication technology or standard to establish a wireless communications link.

In some embodiments, the network 250 can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 250.

In the illustrated embodiment, communication hardware associated with the communication paths between the devices includes switches, routers, cables, modems, adapters, power supplies, etc. Communication software associated with the communication paths includes instructions and other software controlling communication protocols and the operation of the communication hardware in accordance with the communication protocols, if any. It is appreciated that other communication path protocols may be utilized, depending upon the particular application.

The primary and secondary control units 202a, 202b may include a storage manager 210a, 210b. Storage managers 210a, 210b may be modules (e.g., program instructions, hardware) in the data storage environment 200 configured to store and retrieve data. The storage managers 210a, 210b may include a storage controller. In some embodiments, the first storage manager 210a includes a set of instructions to process an I/O request (e.g., a read, delete, insert, update, and/or write of data) received by the host device 232 onto the first storage 220a.

The storage managers 210a, 210b can also include a set of instructions to maintain a copy of the first storage 220a on the second storage 220b of the primary and secondary control units, which may be considered separate storage systems. The storage systems may comprise enterprise storage servers, such as the IBM Enterprise Storage Server (ESS), for example. The storage managers 210a, 210b managing the first copy relationship may implement synchronous copy operations, such as a peer-to-peer remote copy (PPRC) program. An example of a program that manages a PPRC program is the IBM® Copy Services Manager (CSM) copy program that enables the switching of updates to the primary storage 220a to the secondary storage 220b. The storage managers 210a, 210b may also implement asynchronous remote copy operations, where updates to the primary storage 220a or secondary storage 220b are mirrored to a corresponding location in at a remote site. Suitable asynchronous minoring programs include Global Mirror and XRC (or zGM). The described operations may be implemented with other programs such as other copy programs or other global recovery programs.

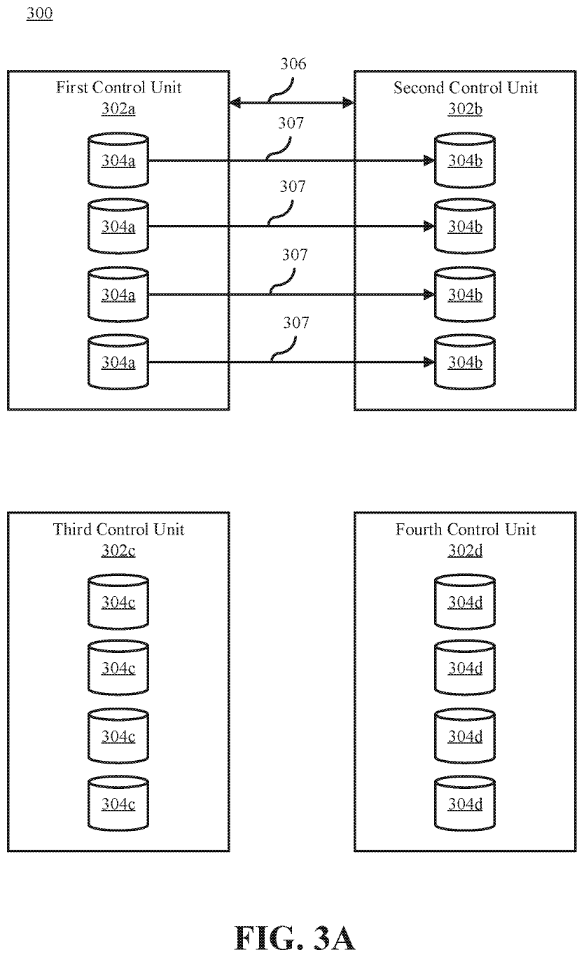

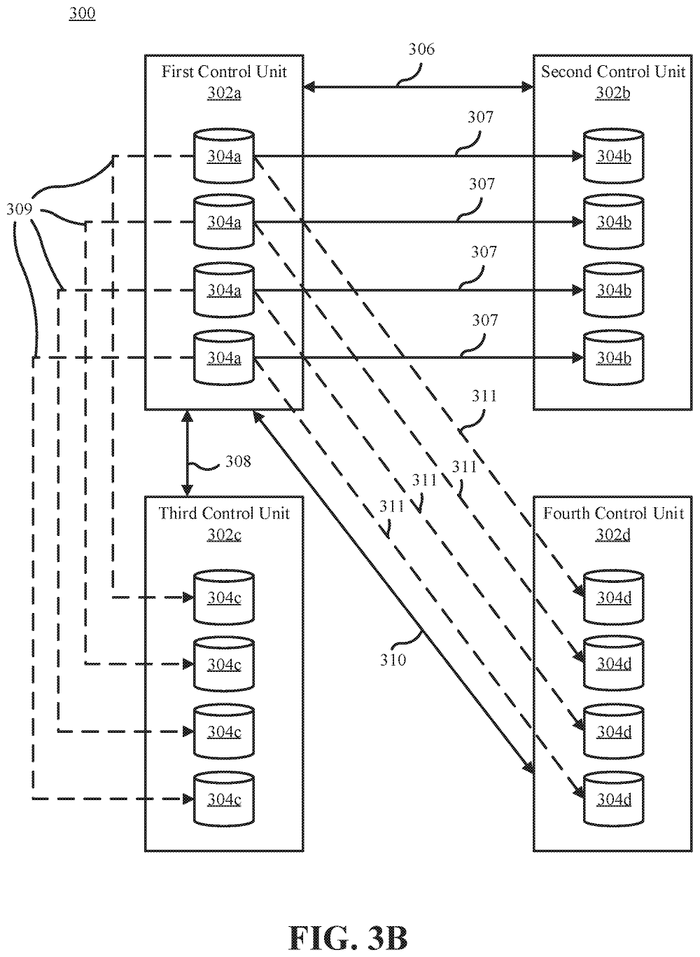

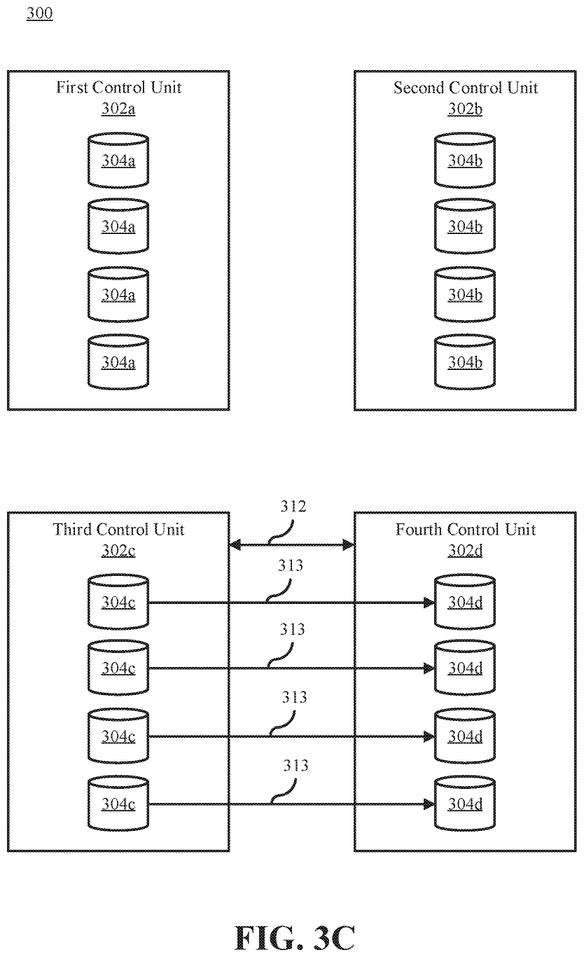

In one illustrative example embodiment, the storage manager(s) 210a, 210b can monitor for a migration command. In response to receiving a migration command, the storage managers 210a, 210b may identify new primary and secondary storage devices (e.g., new control units that are not shown in FIG. 2), and the storage managers 210a, 210b can perform the data migration. The specific steps for performing a data migration to new storage devices is discussed in more detail in reference to FIGS. 3A-5.

The first and second storages 220a, 220b may comprise different types or classes of storage devices. For example, the first and second storages 220a, 220b may include magnetic hard disk drives, solid state storage devices (SSDs), Electrically Erasable Programmable Read-Only Memory (EEPROM), flash memory, flash disk, Random-Access Memory (RAM), storage-class memory (SCM), Phase Change Memory (PCM), Resistive Random-Access Memory (RRAM), optical disk, tape, etc. Further, the first and second storages 220a, 220b may be configured as an array of devices, such as a Just a Bunch of Disks (JBOD), Direct Access Storage Device (DASD), or Redundant Array of Independent Disks (RAID) array.

It is noted that FIG. 2 is intended to depict the representative major components of an exemplary computing environment 200. In some embodiments, however, individual components may have greater or lesser complexity than as represented in FIG. 2, components other than or in addition to those shown in FIG. 2 may be present, and the number, type, and configuration of such components may vary. Likewise, one or more components shown within the computing environment 200 may not be present, and the arrangement of components may vary.

For example, while FIG. 2 illustrates a computing environment 200 with a single host device 232 and two control units 202a, 202b, suitable computing environments for implementing embodiments of this disclosure may include any number of control units and host devices. For example, as discussed in more detail below, the computing environment 200 may include at least four control units. The various models, modules, systems, and components illustrated in FIG. 2 may exist, if at all, across a plurality of host devices and control units.

For example, in some embodiments, the storage managers 210a, 210b may not be a part of the primary and secondary control units 202a, 202b, or only one of the primary and secondary control units 202a, 202b may include a storage manager. In some embodiments, the storage manager may be a standalone device distinct from the primary and secondary control units. In these embodiments, the storage manager may be communicatively coupled with any of the primary and secondary control units 202a, 202b and/or the first and second storages 220a, 220b (e.g., over the network 250). As another example, some embodiments may include two (or more) host devices. Each host device may be connected to two (or more) control units. Likewise, the primary and secondary control units 202a, 202b may be connected to, and store data for, two or more host devices.

Referring now to FIGS. 3A-3C, shown are block diagrams depicting a storage environment 300 during migration from old primary and secondary storage devices (referred to in the figures as first control unit 302a and second control unit 302b, respectively) to new primary and secondary storage devices (referred to in the figures as third control unit 302c and fourth control unit 302d, respectively), in accordance with embodiments of the present disclosure. In this example, we will assume that the client currently has a two-site storage replication solution that is HyperSwap enabled providing high availability and wishes to migrate to newer storage system technology that is also a two-site storage replication solution that is also HyperSwap enabled. However, it is to be understood that this is for illustrative purposes only. Embodiments of the present disclosure could also be used if the starting solution is a three-site metro-global mirror solution or even a multi-target metro mirror/global mirror solution, although the latter would require that multi-target be enhanced to support all four targets that are architecturally supported.

Starting with FIG. 3A, shown is a block diagram of the environment 300 prior to migration. In particular, as shown in FIG. 3A, the environment 300 includes four control units 302a, 302b, 302c, and 302d (collectively and/or individually referred to as control unit(s) 302). Each control unit 302 includes a set of volumes 304. In particular, the first control unit 302a includes a first set of volumes 304a, the second control unit 302b includes a second set of volumes 304b, and so on. The first control unit 302a acts as the primary storage device for the client, while the second control unit 302b acts as the secondary storage device for the client.

As mentioned above, the first and second control units 302a, 302b have a mirror replication relationship with HyperSwap enabled, as indicated by arrow 306. As such, each volume 304a in the first control unit 302a has an associated volume 304b in the second control unit 302b. This is represented by the arrows 307. In other words, each volume 302a has an identical copy 304b, and any data that is written to the first set of volumes 304a is also written to the second set of volumes 304b.

Meanwhile, at this stage, the new storage system that the client is migrating to is created. The new storage system include the third and fourth control units 302c, 302d. The third control unit 302c will become the new primary storage system/device after the migration, and the fourth control unit 302d will become the new secondary storage system/device after the migration. As will be shown in FIG. 3C, the third and fourth control units 302c, 302d will have a mirror replication relationship with HyperSwap enabled following migration. Setting up the new storage system includes creating the third set of volumes 304c and the fourth set of volumes 304d on the third and fourth control units 302c, 302d, respectively.

Referring now to FIG. 3B, shown is the storage environment 300 during migration of the old storage systems to the new storage systems, in accordance with embodiments of the present disclosure. In particular, as shown in FIG. 3B, a replication relationship 308 is created between the first control unit 302a and the third control unit 302c. Additionally, a replication relationship 310 is created between the first control unit 302a and the fourth control unit 302d. Meanwhile, the mirror replication relationship 306 with HyperSwap enabled between the first control unit 302a and the second control unit 302b is maintained.

Once the replication relationships 308, 310 between the first control unit 302a and the third and fourth control units 302c, 302d are established, data replication may begin. This is represented by the arrows 309, 311 connecting the first set of volumes 304a to the third and fourth sets of volumes 304c, 304d, respectively. In some embodiments, the data replication may begin automatically once the replication relationships 308, 310 are created (e.g., in response to the migration command) or at a specific time thereafter (e.g., when data operations on the first set of volumes 304a are low) to minimize impact of the replications. In other embodiments, a user (e.g., the client) may decide when to start the replications (e.g., by providing a command to start replicating using a graphical user interface (GUI)).

Regardless of whether the data replication is triggered by a computer system or a user, data replication between the first control unit 302a and the third and fourth control units 302c, 302d may initially be done using asynchronous replication. This may help avoid application impact of the replication by reducing the total number of write operations that are occurring at any given time and allowing I/O to continue to the primary volumes even though the data has yet to be replicated to the secondary volumes. In these embodiments, the time to replicate the data may be higher. Meanwhile, data may still be written to the second control unit 302b synchronously with the first control unit 302a to maintain high availability and data integrity between the control units 302a, 302b.

In some embodiments, data replication to one or both of the third and fourth control units 302c, 302d may be done synchronously. This may be done depending on, for example, the distance between the control units, the bandwidth capabilities between the control units, the (predicted or actual) amount of impact on application performance, and/or the quality of service (QoS) or acceptable level of performance for the application. In some embodiments, the data replication may switch from asynchronous to synchronous (or the other way around) as these factors change.

Once the data replication from the first control unit 302a and the third and fourth control units 302c, 302d has reached a state where the out of synch tracks between all relationships is within a threshold amount, the migration process can be initiated. The threshold amount may depend on the amount of I/O being driven to the first control unit 302a. In some embodiments, the threshold amount may be close to 100%. The reason for the threshold is that embodiments of the present disclosure may require that all storage systems are in synchronous copy mode in order to ensure they all have the same data to allow for the HyperSwap to occur. However, the system will typically never be able to reach 100% since work is continuing to update the primary control unit 302a and updates are not synchronous. So at some point, the system will no longer be getting any closer to 100%, and at this point the system will have to switch over to synchronous mirroring in order to get to 100% and therefore move to the next step. The out of sync tracks should be low so that when the relationships are switched from asynchronous replication to synchronous, the relationships can reach a state of 100% copied quickly, allowing for the migration to occur with as minimal application impact as possible. In other words, by ensuring the pairs are as “in-sync” as possible, the amount of time required to sync and swap can be minimized.

In some embodiments, how far from 100% this threshold is will depend on a few things, including, but not limited to, how much I/O activity—in particular writes or updates—is occurring on the primary volume and the bandwidth between the primary and secondary controllers. It may also vary by client and by the time of day (e.g., activity may be higher during trading hours for a financial corporation).

In some embodiment, the system can automatically initiate the migration process once the threshold has been reached. In other embodiments, a user may have to trigger initiation of the migration process. In some embodiments, the user may only be able to initiate the migration process after the threshold has been reached, while in other embodiments the user may be able to override the threshold. In some embodiments, the system may not automatically migrate upon reaching the threshold. For example, if the above financial company gets to this “steady state” (e.g., of 97%) during trading hours, they will often take the conservative approach of waiting until trading ends—if not 2:00 in the morning — before switching to synchronous mirroring, just to be safe. In any case, the system and/or the user initiates the migration be issuing a command, which is referred to herein as the “prepared for migration” command.

Upon receiving the prepared for migration command from the user or automated system, the replication type between the first control unit 302a and the third and fourth control units 302c, 302d will be converted to synchronous replication if they are not already synchronous. Data replication will then continue until all three role pairs have reached full duplex status, at which point the controlling software such as CSM will load the HyperSwap configuration for the first control unit 302a to third control unit 302c relationship. The HyperSwap configuration may enable HyperSwap for unplanned swaps or it may disable HyperSwap for unplanned swaps, leaving it available only for migration. In some embodiments, the default may be to disable unplanned swaps so that I/O does not move to the new box until the user explicitly indicates it should.

In some embodiments, the migration may occur even before all three role pairs have reached full duplex status in the event of an issue, such as problems mirroring data between the first control unit 302a and the second control unit 302b. This may be a result of a problem or failure of the second control unit 302b itself or a communication failure (e.g., if a network connecting them goes down). If such a failure occurs, because the systems are no longer mirroring between the old devices and therefore are no longer HyperSwap capable, the system might as well proceed to migrate to the new devices (i.e., the third and fourth control units 302c, 302d) which are mirroring and are HyperSwap capable. Depending on what caused the mirroring to stop between the first and second control units 302a and 302b, performing this unexpected early migration may be the most expedient way for the system to become HyperSwap enabled again.

When full duplex between the first control unit 302a and the third control unit 302c has been reach and HyperSwap has been enabled, and full duplex between the first control unit 302a and the fourth control unit 302d has been reach, the actual migration can be initiated through a migrate command. The actual migration may be initiated automatically upon the above conditions having been met, or it may be initiated by a user. Once the migrate command has been issued, the system will proceed to switch the primary and secondary storage systems over to the new storage systems (e.g., using a failover process such as HyperSwap).

Unlike current processes for migrating to a new storage system, however, after performing the swap phase and before performing the resume I/O phase, the system performs a new phase. The new phase will failover or terminate the first control unit 302a to fourth control unit 302d relationship 310 and establish a third control unit 302c to fourth control unit 302d replication relationship 312 in synchronous mode, as shown in FIG. 3C. This may be done using multi-target incremental failback support, which is available on a number of storage systems including the DS8000 series storage systems by IBM. Alternatively, the third control unit 302c to fourth control unit 302d replication relationship 312 can also be established with a “no copy” option if multi-target support is not available. In any event, creating the third control unit 302c to fourth control unit 302d replication relationship 312 includes creating relationships between the third set of volumes 304c and the fourth set of volumes 304d, as shown by the arrows 313 in FIG. 3C.

Furthermore, before proceeding to the resume I/O phase and after the third control unit 302c to fourth control unit 302d replication has successfully been started, the system will replace the HyperSwap configuration between the first and second control units 302a, 302b with the corresponding HyperSwap configuration between the third and fourth control units 302c, 302d. This may include deleting the HyperSwap configuration between the HyperSwap configuration between first control unit 302a and the third control unit 302c, which is no longer needed.

Once HyperSwap is fully enabled between the third and fourth control units 302c, 302d, the system will then proceed to the resume I/O phase, where I/O operations that have been queued up during the migration are executed against the third control unit 302c and mirrored to the fourth control unit 302d. After resume I/O is complete, work can continue on the new (i.e., migrated-to) volumes 304c on the third control unit 302c, which now acts as the primary control unit for the system, and the migration is complete, except for some cleanup operation.

After completing the migration, the system can either automatically or manually allow the user to terminate the relationships between the first and second control units 302a, 302b, as shown by the arrows being removed in FIG. 3C. Furthermore, after the migration is complete and the relationships between the first and second control units 302a, 302b have been terminated, the resulting configuration looks like that shown in FIG. 3C.

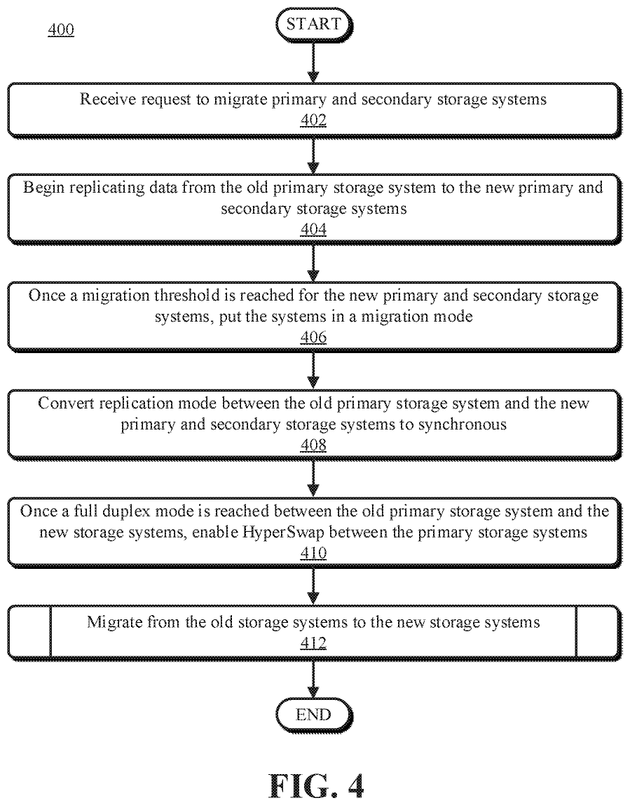

Referring now to FIG. 4, illustrated is a flowchart of an example method 400 for migrating from old storage systems to new storage systems using a multi-storage volume swap, in accordance with embodiments of the present disclosure. The method 400 may be performed by hardware, firmware, software executing on a processor, or any combination thereof. For example, the method 400 may be performed by a processor (e.g., in a host device 232).

The method may begin at operation 402, wherein a system (e.g., a storage system/server) or storage subsystem (e.g., if integrated in a server with computer hardware) may receive a request to migrate to new primary and secondary storage systems (e.g., new storage devices, also referred to herein as control units). This may be done, for example, during a hardware upgrade where the old storage devices are replaced by new storage devices.

At operation 404, the system begins replicating data from the old primary storage system to the new primary and secondary storage systems. In some embodiments, operation 404 may include one or more suboperations. The one or more suboperations may include first identifying suitable storage devices to act as the new primary and secondary storage systems. One or more suitable replacement source storage devices in a replacement source storage subsystem may be identified automatically with little or no human operator intervention. For example, the copy management software can, in response to a command to initiate the change of the source storage units, automatically identify a list of candidate replacement source storage devices, and in a suitable user interface, present the list of candidate replacement source storage devices to a human operator. In response, the human operator may select suitable replacement source storage devices from the list of candidate replacement source storage devices. In one embodiment, candidate replacement source storage devices in a storage subsystem may already be defined as being managed by the storage management software.

In the example above, the copy management software can fully automatically identify a list of candidate replacement source storage devices, and in a suitable user interface, present the list of candidate replacement source storage units to a human operator. In response, the human operator may select suitable replacement source storage devices from the list of candidate replacement source storage devices. In this manner, the replacement source storage devices may be identified in a predominantly automatic fashion. In other embodiments, the replacement source storage devices may be identified fully automatically, that is, without human intervention, or may be identified manually by a human operator and the selection manually input into a graphical user interface.

Operation 404 may further include identifying copy relationships that are to be migrated to the new primary and secondary storage systems. In some embodiments, the copy management software can, in response to a command to initiate the change of the primary and secondary storage devices, fully automatically identify a list of candidate copy relationships to be migrated, and in a suitable user interface, present the list of candidate copy relationships to be migrated to a human operator. In response, the human operator may select one or more suitable copy relationships to be migrated from the list of candidate replacement copy relationships to be migrated. In this manner, the replacement copy relationships to be migrated may be identified in a predominantly automatic fashion. In other embodiments, the copy relationships may be identified automatically by the system. For example, the system may determine that all copy relationships between the old primary and secondary storage systems may be migrated over to the new primary and secondary storage systems.

Operation 404 may further include identifying the sets of volumes on the new primary and secondary storage systems that will include the replicated data from the old storage systems. In some embodiments, this may involve creating a new set of volumes on each of the new primary and secondary storage systems. The new sets of volumes may be created such that the new primary and secondary storage systems have volumes that correspond to each of the volumes that are being migrated. In other embodiments, the sets of volumes may already exist on the new primary and secondary storage systems. In these embodiments, the storage manager may use a target volume matching algorithm to create copy relationship pairings between the volumes of the old primary storage subsystem and the volumes of a new source storage systems based on volume size and type. They system may then start replicating data from the old primary storage system to the new primary and secondary storage systems.

At operation 406, once a migration threshold has been reached for the new primary and secondary storage systems, the old and new storage systems may be put in a migration mode. As discussed herein, the threshold may be an amount of data such that the amount of time required for the systems to reach full duplex status is sufficiently low so as to not severely impact application performance. Furthermore, at operation 408, the replication mode between the old primary storage system and the new primary and secondary storage systems are converted to synchronous. This ensures that new I/O writes that are executed against the old primary storage system are also executed against both the new primary storage system and the new secondary storage system, thereby ensuring data integrity.

At operation 410, once full duplex mode or status has been reached, a multi-storage volume swap (e.g., HyperSwap) is enabled between the old primary storage system and the new primary storage system. Enabling a multi-storage volume swap, as discussed herein, means that the applicable program (e.g., HyperSwap) is aware (e.g., from the CSM) of all of the volumes that are part of the multi-storage volume swap session and has confirmed that it can actually access those volumes. It may further include the multi-storage volume swap program confirming that all volume pairs are currently in a full duplex state and being mirrored.

At operation 412 the migration is initiated. In some embodiments, the storage management can automatically issue the migration command once full duplex status has been achieved for the migration and HyperSwap has been enabled. For example, a multi-storage volume swap command automatically issued by the storage management may be a HyperSwap® in accordance with the present description. HyperSwap will first temporarily quiesce I/O operations while the swap is taking place. In some embodiments, the I/O operations which have already started when the multi-storage volume swap is initiated, may be permitted to complete. Any subsequent I/O operations may be placed in a queue at the originating host to await completion of the multi-storage volume swap operation. It is appreciated that in other embodiments, the quiescing of the I/O operations may be performed manually.

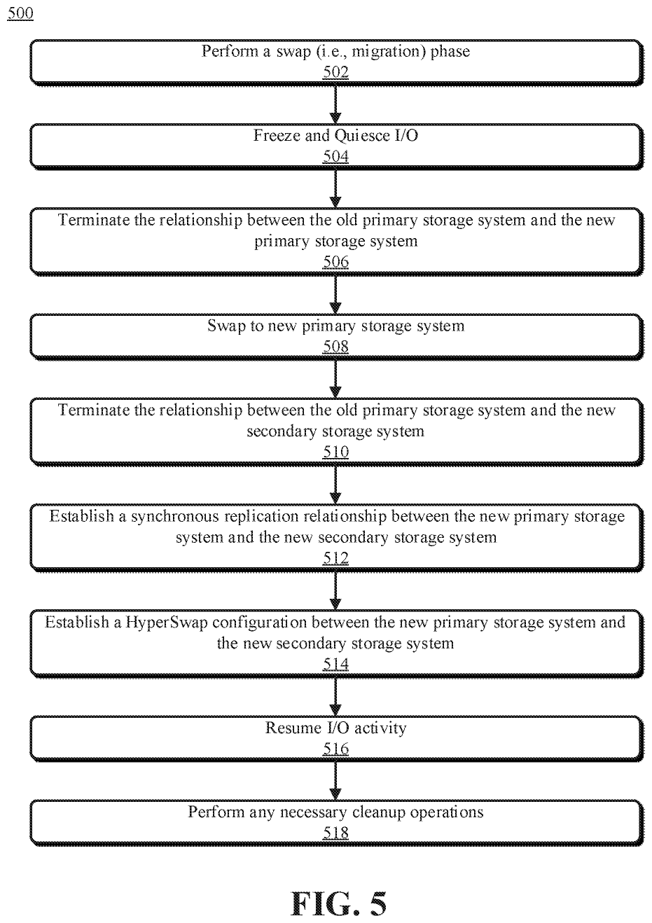

Once I/O operations have been quiesced, a multi-storage volume swap from the old primary storage system to the new primary and secondary storage systems is initiated, and the old storage systems are migrated to the new storage systems, and the method 400 ends. The method 500 discussed with respect to FIG. 5 is an illustrative example of the suboperations that may be performed in order to migrate from the old storage systems to the new storage systems at operation 412.

Referring now to FIG. 5, illustrated is a flowchart of an example method 500 for migrating from old storage systems to new storage systems using a multi-storage volume swap, in accordance with embodiments of the present disclosure. The method 500 may be performed by hardware, firmware, software executing on a processor, or any combination thereof. For example, the method 500 may be performed by a processor (e.g., in a host device 232).

The method 500 may begin at operation 502, wherein a swap phase may be performed. In some embodiments, the storage manager can automatically issue a swap initiation command. The swap initiation command may prepare the system to swap from the volumes of the old primary storage system to the volumes of the new primary and secondary storage systems. In some embodiments, the swap initiation command may be automatically sent once full duplex of the copy relationship pairs of the old primary storage system and the new primary and secondary storage systems have been reached.

In response to the swap initiation command, the system may freeze and quiesce I/O. This is illustrated at operation 504. Any unexecuted I/O commands, including new I/O commands that are received after the I/O has been frozen, may be stored in an I/O queue.

At operation 506, the relationships between the old primary storage system and the new primary storage system may be terminated. This action can now be done since the old primary storage system and the new primary storage system have, by this point, reached full duplex status, and because the I/O operations have been frozen, ensuring that they remain in full duplex status.

At operation 508, the system swaps to the new primary storage system. In some embodiments, a multi-storage volume swap function such as HyperSwap® may be modified in accordance with the present description to provide the swap from the volumes of the original source storage subsystem to the volumes of the replacement source storage subsystem. In this embodiment, the HyperSwap® function is modified for use in facilitating the migration operation.

At operation 510, the relationship between the old primary storage system and the new secondary storage system may be terminated. This may not be done until full duplex mode/status has been reached. Once full duplex mode/status is reached and the I/O operations have been quiesced, no more data will need to be copied to the new secondary storage system until the migration is complete, at which point it will be in a copy relationship with the new primary data system. As such, the relationship the old primary storage system and the new secondary storage system is no longer needed.

At operation 512, a synchronous replication relationship is established between the new primary storage system and the new secondary storage system. Additionally, a multi-storage swap configuration (e.g., a HyperSwap configuration) is created for the new primary and secondary storage systems. This is shown at operation 514. The creation of the synchronous replication relationship and the multi-storage swap configuration between the new primary and secondary storage systems enable high availability and failover functionality, and ensure data integrity between the new storage systems.

At operation 516, I/O resume operations are performed and the queued I/O operations are executed on the new primary and secondary storage systems. Any necessary cleanup operations are then performed on the new storage systems at operation 518, and the method 500 ends. The cleanup operations performed at operation 518 may include terminating relationships between the old storage devices. For example, the synchronous mirroring relationship between the old primary storage system and the old secondary storage system may be terminated. In addition, the multi-storage swap configuration (e.g., a HyperSwap configuration) between the old primary storage system and the old secondary storage system is deleted during the cleanup operation 518.

It is seen from the above that storage management in accordance with the present description can provide an automated process to migrate data from one source volume to another while maintaining disaster recovery capability, and substantially obviating extra data and data copying which typically resulted in use of prior procedures. Thus, disaster recovery capability may be maintained throughout the data migration. In addition, a migration operation may be completed with very brief or no interruption of ongoing I/O operations. As a result, it is believed that users will be able to migrate data in situations where it may have previously been impractical, such as for example while business critical work is being executed.

Thus, in one aspect of the present description, the migration of a storage system configured for disaster recovery may be undertaken with little or no impact upon the disaster recovery capability between the original primary and secondary volumes. In one embodiment, a multi-storage volume swap function such as HyperSwap®, for example, is utilized and may be modified to automate the migration of data onto a new source storage subsystem without requiring the user to manually remove existing copy relationships or to create new copy relationships. It is believed that storage management in accordance with the present description may save the user significant time while reducing opportunity for error which may occur in attempts to create thousands of copy relationship pairs manually.

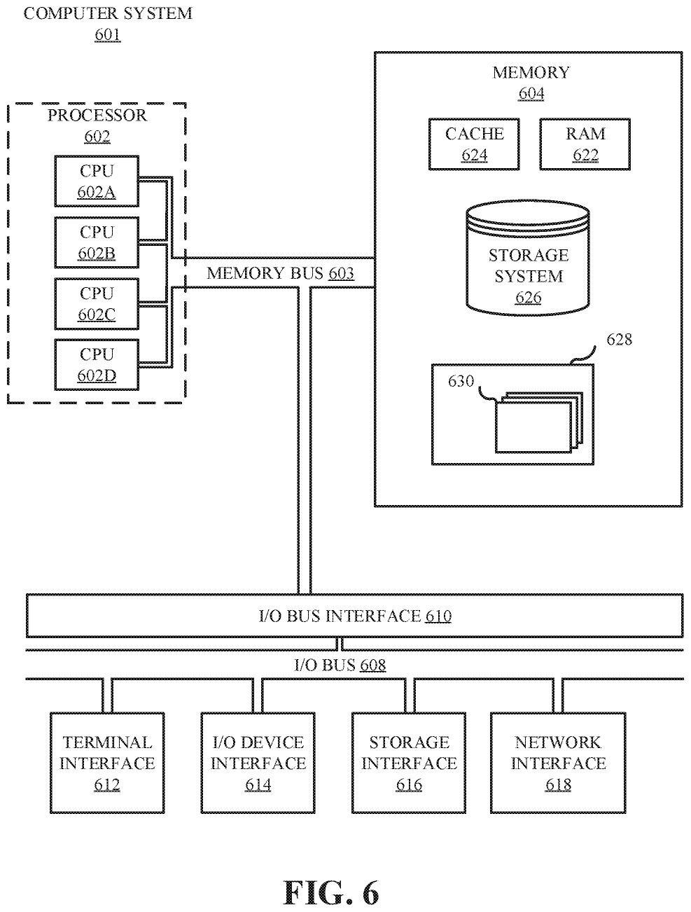

Referring now to FIG. 6, shown is a high-level block diagram of an example computer system 601 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Program modules 630 generally perform the functions or methodologies of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary. Furthermore, the modules are listed and described illustratively according to an embodiment and are not meant to indicate necessity of a particular module or exclusivity of other potential modules (or functions/purposes as applied to a specific module).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

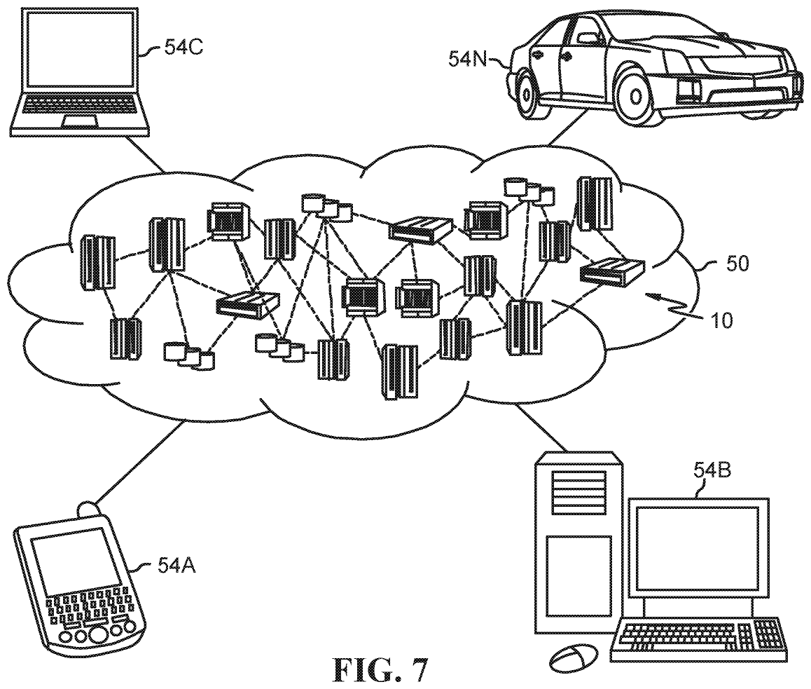

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

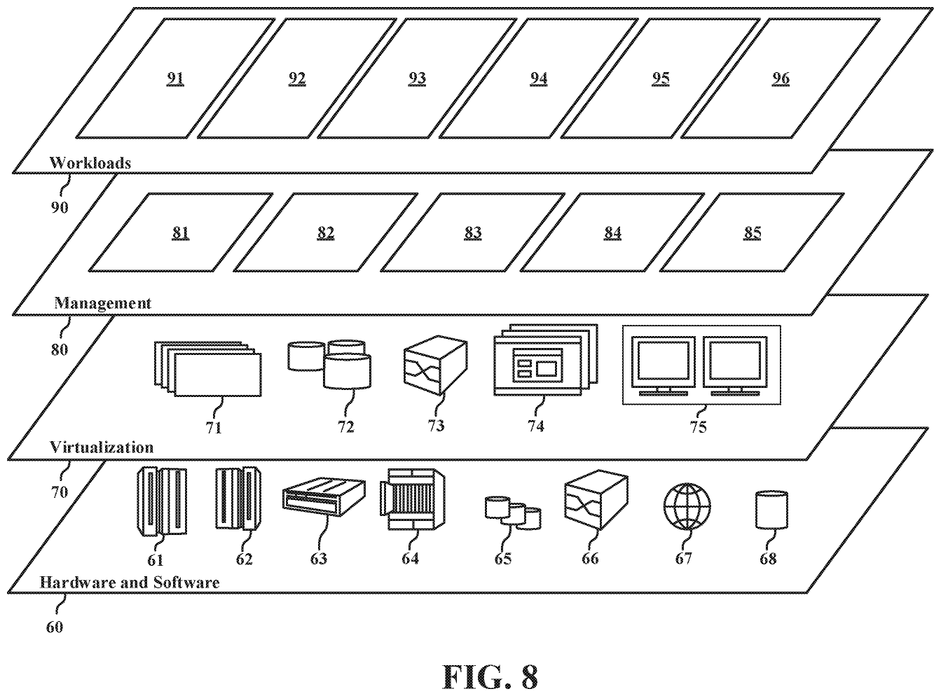

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and storage migration 96. The storage migration 96 may include instructions for performing various functions disclosed herein, such as enabling migration of old primary and secondary storage systems to new primary and secondary storage systems while maintaining high availability and HyperSwap® functionality.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications, alterations, and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s). Additionally, it is intended that the following claim(s) be interpreted as covering all such alterations and modifications as fall within the true spirit and scope of the invention.

A non-limiting list of Example Embodiments are provided hereinafter to demonstrate some aspects of the present disclosure.

Example Embodiment 1 is a method. The method includes receiving a command to migrate from a first storage system to a second storage system, wherein the first storage system comprises a first primary storage and a first secondary storage, and wherein the second storage system comprises a second primary storage and a second secondary storage. The method further includes initiating, in response to receiving the command, data replication between the first primary storage and the second primary storage. The method further includes initiating, in response to receiving the command, data replication between the first primary storage and the second secondary storage. The method further includes migrating from the first storage system to the second storage system.

Example Embodiment 2 includes the method of Example Embodiment 1, including or excluding optional features. In this Example Embodiment, initiating data replication between the first primary storage and the second primary storage comprises identifying a first set of volumes to be migrated on the first primary storage, identifying a second set of suitable volumes on the second primary storage for receiving the first set of volumes, and mirroring data of the first set of volumes onto the second set of volumes. Optionally, the method further comprises initiating data replication between the first primary storage and the second secondary storage by identifying a third set of suitable volumes on the second secondary storage for receiving the first set of volumes and mirroring data of the first set of volumes onto the third set of volumes.

Example Embodiment 3 includes the method of any one of Example Embodiments 1 to 2, including or excluding optional features. In this Example Embodiment, initiating data replication between the first primary storage and the second secondary storage comprises identifying a first set of volumes to be migrated on the first primary storage. Initiating data replication further comprises creating a second set of volumes on the second secondary storage for receiving the first set of volumes. The second set of volumes have properties that are suitable for receiving data of the first set of volumes. Initiating data replication further comprises mirroring the data of the first set of volumes onto the second set of volumes. Optionally, the properties include a volume size and type. Optionally, the method further comprises initiating data replication between the first primary storage and the second primary storage by creating a third set of suitable volumes on the second primary storage for receiving the first set of volumes. The third set of volumes have properties that are suitable for receiving data of the first set of volumes. Initiating data replication further comprises mirroring the data of the first set of volumes onto the third set of volumes.

Example Embodiment 4 includes the method of any one of Example Embodiments 1 to 3, including or excluding optional features. In this Example Embodiment, the method includes preparing, in response to the data replication between the first primary storage and both of the second primary storage and secondary storage reaching a threshold completion level, the second storage system for migration prior to migrating from the first storage system to the second storage system. Optionally, preparing the second storage system for migration comprises converting a replication mode between the first primary storage and the second primary storage to synchronous, and converting a replication mode between the first primary storage and the second secondary storage to synchronous. Optionally, preparing the second storage system for migration further comprises enabling, in response to full duplex status being reached between the first primary storage and both the second primary storage and the second secondary storage, multi-storage volume swapping between the first primary storage and the second primary storage.

Example Embodiment 5 includes the method of any one of Example Embodiments 1 to 4, including or excluding optional features. In this Example Embodiment, migrating from the first storage system to the second storage system is in response to full duplex status being reached between the first primary storage and both the second primary storage and the second secondary storage. Optionally, migrating from the first storage system to the second storage system comprises suspending I/O operations and storing received I/O operations in a queue for subsequent processing. Optionally, migrating from the first storage system to the second storage system further comprises terminating a data replication relationship between the first primary storage and the second secondary storage, enabling a synchronous data replication relationship between the second primary storage and the second secondary storage, and enabling multi-storage volume swapping between the second primary storage and the second secondary storage. Optionally, migrating from the first storage system to the second storage system further comprises executing the queued 110 operations on the second primary storage.

Example Embodiment 6 includes the method of any one of Example Embodiments 1 to 5, including or excluding optional features. In this Example Embodiment, the first primary storage is initially configured to mirror data to the first secondary storage. The method further includes terminating, after migrating to the second storage system, relationships between the first primary storage and the first secondary storage, and executing new 110 operations on the second storage system. Optionally, data may not be mirroring between the first primary storage and the first secondary storage. This may be a result of, for example, an error with the first secondary storage or the communication network(s) between the first primary storage and the first secondary storage.

Example Embodiment 7 is a system. The system includes a memory and a processor communicatively coupled to the memory, wherein the processor is configured to perform a method. The method includes receiving a command to migrate from a first storage system to a second storage system, wherein the first storage system comprises a first primary storage and a first secondary storage, and wherein the second storage system comprises a second primary storage and a second secondary storage. The method further includes initiating, in response to receiving the command, data replication between the first primary storage and the second primary storage. The method further includes initiating, in response to receiving the command, data replication between the first primary storage and the second secondary storage. The method further includes migrating from the first storage system to the second storage system

Example Embodiment 8 includes the system of Example Embodiment 7, including or excluding optional features. In this Example Embodiment, initiating data replication between the first primary storage and the second primary storage comprises: identifying a first set of volumes to be migrated on the first primary storage, identifying a second set of suitable volumes on the second primary storage for receiving the first set of volumes, and mirroring data of the first set of volumes onto the second set of volumes.

Example Embodiment 9 includes the system of any one of Example Embodiments 7 to 8, including or excluding optional features. In this Example Embodiment, the method further comprises preparing, in response to the data replication between the first primary storage and both of the second primary storage and secondary storage reaching a threshold completion level, the second storage system for migration prior to migrating from the first storage system to the second storage system. Optionally, preparing the second storage system for migration comprises converting a replication mode between the first primary storage and the second primary storage to synchronous and converting a replication mode between the first primary storage and the second secondary storage to synchronous. Optionally, preparing the second storage system for migration further comprises enabling, in response to full duplex status being reached between the first primary storage and both the second primary storage and the second secondary storage, multi-storage volume swapping between the first primary storage and the second primary storage.

Example Embodiment 10 includes the system of any one of Example Embodiments 7 to 9, including or excluding optional features. In this Example Embodiment, migrating from the first storage system to the second storage system is in response to full duplex status being reached between the first primary storage and both the second primary storage and the second secondary storage. Optionally, migrating from the first storage system to the second storage system comprises suspending I/O operations and storing received I/O operations in a queue for subsequent processing. Optionally, migrating from the first storage system to the second storage system further comprises terminating a data replication relationship between the first primary storage and the second secondary storage, enabling a synchronous data replication relationship between the second primary storage and the second secondary storage, and enabling multi-storage volume swapping between the second primary storage and the second secondary storage.

Example Embodiment 11 is a computer program product comprising a computer readable storage medium having program instructions embodied therewith. The computer-readable medium includes instructions that direct the processor to perform a method. The method includes receiving a command to migrate from a first storage system to a second storage system, wherein the first storage system comprises a first primary storage and a first secondary storage, and wherein the second storage system comprises a second primary storage and a second secondary storage. The method further includes initiating, in response to receiving the command, data replication between the first primary storage and the second primary storage. The method further includes initiating, in response to receiving the command, data replication between the first primary storage and the second secondary storage. The method further includes migrating from the first storage system to the second storage system.

Example Embodiment 12 includes the computer-readable medium of Example Embodiment 11, including or excluding optional features. In this Example Embodiment, the method further comprises preparing, in response to the data replication between the first primary storage and both of the second primary storage and secondary storage reaching a threshold completion level, the second storage system for migration prior to migrating from the first storage system to the second storage system.

Example Embodiment 13 includes the computer-readable medium of any one of Example Embodiments 11 to 12, including or excluding optional features. In this Example Embodiment, preparing the second storage system for migration comprises converting a replication mode between the first primary storage and the second primary storage to synchronous, converting a replication mode between the first primary storage and the second secondary storage to synchronous, and enabling, in response to full duplex status being reached between the first primary storage and both the second primary storage and the second secondary storage, multi-storage volume swapping between the first primary storage and the second primary storage.

Example Embodiment 14 is a method. The method includes receiving a command to migrate from a first storage system to a second storage system. The first storage system comprises a first primary storage and a first secondary storage, and the second storage system comprises a second primary storage and a second secondary storage. The method further includes replicating, in response to receiving the command, data between the first primary storage and the second primary storage. The method further includes replicating, in response to receiving the command, data between the first primary storage and the second secondary storage. The method further includes, in response to full duplex status being reached between the first primary storage and both the second primary storage and the second secondary storage, suspending I/O operations received for executing on the first storage system, storing the I/O operations in a queue, and enabling multi-storage volume swapping between the second primary storage and the second secondary storage. The method further includes migrating from the first storage system to the second storage system such that new received I/O operations are executed on the second storage system. The method further includes resuming I/O operations and executing the queued I/O operations on the second storage system.

Example Embodiment 15 is a system. The system includes a memory and a processor communicatively coupled to the memory. The processor is configured to perform a method. The method includes receiving a command to migrate from a first storage system to a second storage system. The first storage system comprises a first primary storage and a first secondary storage, and the second storage system comprises a second primary storage and a second secondary storage. The method further includes replicating, in response to receiving the command, data between the first primary storage and the second primary storage. The method further includes replicating, in response to receiving the command, data between the first primary storage and the second secondary storage. The method further includes, in response to full duplex status being reached between the first primary storage and both the second primary storage and the second secondary storage, suspending I/O operations received for executing on the first storage system, storing the I/O operations in a queue, and enabling multi-storage volume swapping between the second primary storage and the second secondary storage. The method further includes migrating from the first storage system to the second storage system such that new received I/O operations are executed on the second storage system. The method further includes resuming I/O operations and executing the queued I/O operations on the second storage system.

What is claimed is:

1. A method comprising:
receiving a command to migrate from a first storage system to a second storage system, wherein the first storage system comprises a first primary storage and a first secondary storage, and wherein the second storage system comprises a second primary storage and a second secondary storage;
initiating, in response to receiving the command, data replication between the first primary storage and the second primary storage;
initiating, in response to receiving the command, data replication between the first primary storage and the second secondary storage; and
migrating from the first storage system to the second storage system.

2. The method of claim 1, wherein initiating data replication between the first primary storage and the second primary storage comprises:
identifying a first set of volumes to be migrated on the first primary storage;
identifying a second set of suitable volumes on the second primary storage for receiving the first set of volumes; and
mirroring data of the first set of volumes onto the second set of volumes.

3. The method of claim 1, wherein initiating data replication between the first primary storage and the second secondary storage comprises:
identifying a first set of volumes to be migrated on the first primary storage;
creating a second set of volumes on the second secondary storage for receiving the first set of volumes, the second set of volumes having properties that are suitable for receiving data of the first set of volumes; and
mirroring the data of the first set of volumes onto the second set of volumes.

4. The method of claim 3, wherein the properties include a volume size and type.

5. The method of claim 1, the method further comprising:
preparing, in response to the data replication between the first primary storage and both of the second primary storage and secondary storage reaching a threshold completion level, the second storage system for migration prior to migrating from the first storage system to the second storage system.

6. The method of claim 5, wherein preparing the second storage system for migration comprises:
converting a replication mode between the first primary storage and the second primary storage to synchronous; and
converting a replication mode between the first primary storage and the second secondary storage to synchronous.

7. The method of claim 6, wherein preparing the second storage system for migration further comprises:
enabling, in response to full duplex status being reached between the first primary storage and both the second primary storage and the second secondary storage, multi-storage volume swapping between the first primary storage and the second primary storage.

8. The method of claim 1, wherein migrating from the first storage system to the second storage system is in response to full duplex status being reached between the first primary storage and both the second primary storage and the second secondary storage.

9. The method of claim 8, wherein migrating from the first storage system to the second storage system comprises:
suspending I/O operations; and
storing received I/O operations in a queue for subsequent processing.

10. The method of claim 9, wherein migrating from the first storage system to the second storage system further comprises:
terminating a data replication relationship between the first primary storage and the second secondary storage;
enabling a synchronous data replication relationship between the second primary storage and the second secondary storage; and
enabling multi-storage volume swapping between the second primary storage and the second secondary storage.

11. The method of claim 10, wherein migrating from the first storage system to the second storage system further comprises:
executing the queued I/O operations on the second primary storage.

12. The method of claim 1, wherein the first primary storage is initially configured to mirror data to the first secondary storage, the method further comprising:
terminating, after migrating to the second storage system, relationships between the first primary storage and the first secondary storage; and
executing new I/O operations on the second storage system.

13. A system comprising:
a memory; and
a processor communicatively coupled to the memory, wherein the processor is configured to perform a method comprising:
receiving a command to migrate from a first storage system to a second storage system, wherein the first storage system comprises a first primary storage and a first secondary storage, and wherein the second storage system comprises a second primary storage and a second secondary storage;
initiating, in response to receiving the command, data replication between the first primary storage and the second primary storage;
initiating, in response to receiving the command, data replication between the first primary storage and the second secondary storage; and
migrating from the first storage system to the second storage system.

14. The system of claim 13, wherein initiating data replication between the first primary storage and the second primary storage comprises:
identifying a first set of volumes to be migrated on the first primary storage;
identifying a second set of suitable volumes on the second primary storage for receiving the first set of volumes; and
mirroring data of the first set of volumes onto the second set of volumes.

15. The system of claim 13, wherein the method further comprises:
preparing, in response to the data replication between the first primary storage and both of the second primary storage and secondary storage reaching a threshold completion level, the second storage system for migration prior to migrating from the first storage system to the second storage system.

16. The system of claim 15, wherein preparing the second storage system for migration comprises:
converting a replication mode between the first primary storage and the second primary storage to synchronous; and
converting a replication mode between the first primary storage and the second secondary storage to synchronous.

17. The system of claim 16, wherein preparing the second storage system for migration further comprises:
enabling, in response to full duplex status being reached between the first primary storage and both the second primary storage and the second secondary storage, multi-storage volume swapping between the first primary storage and the second primary storage.

18. The system of claim 13, wherein migrating from the first storage system to the second storage system is in response to full duplex status being reached between the first primary storage and both the second primary storage and the second secondary storage.

19. The system of claim 18, wherein migrating from the first storage system to the second storage system comprises:
suspending I/O operations; and
storing received I/O operations in a queue for subsequent processing.

20. The system of claim 19, wherein migrating from the first storage system to the second storage system further comprises:
terminating a data replication relationship between the first primary storage and the second secondary storage;
enabling a synchronous data replication relationship between the second primary storage and the second secondary storage; and
enabling multi-storage volume swapping between the second primary storage and the second secondary storage.

21. A computer program product comprising a computer readable storage medium having program instructions embodied therewith, the program instructions executable by a computer to perform a method comprising:
receiving a command to migrate from a first storage system to a second storage system, wherein the first storage system comprises a first primary storage and a first secondary storage, and wherein the second storage system comprises a second primary storage and a second secondary storage;
initiating, in response to receiving the command, data replication between the first primary storage and the second primary storage;
initiating, in response to receiving the command, data replication between the first primary storage and the second secondary storage; and
migrating from the first storage system to the second storage system.

22. The computer program product of claim 21, wherein the method further comprises:
preparing, in response to the data replication between the first primary storage and both of the second primary storage and secondary storage reaching a threshold completion level, the second storage system for migration prior to migrating from the first storage system to the second storage system.

23. The computer program product of claim 21, wherein preparing the second storage system for migration comprises:
converting a replication mode between the first primary storage and the second primary storage to synchronous;
converting a replication mode between the first primary storage and the second secondary storage to synchronous; and
enabling, in response to full duplex status being reached between the first primary storage and both the second primary storage and the second secondary storage, multi-storage volume swapping between the first primary storage and the second primary storage.

24. A method comprising:
receiving a command to migrate from a first storage system to a second storage system, wherein the first storage system comprises a first primary storage and a first secondary storage, and wherein the second storage system comprises a second primary storage and a second secondary storage;
replicating, in response to receiving the command, data between the first primary storage and the second primary storage;
replicating, in response to receiving the command, data between the first primary storage and the second secondary storage;
in response to full duplex status being reached between the first primary storage and both the second primary storage and the second secondary storage:
suspending I/O operations received for executing on the first storage system;
storing the I/O operations in a queue; and
enabling multi-storage volume swapping between the second primary storage and the second secondary storage;
migrating from the first storage system to the second storage system such that new received I/O operations are executed on the second storage system;
resuming I/O operations; and
executing the queued I/O operations on the second storage system.

25. A system comprising:
a memory; and
a processor communicatively coupled to the memory, wherein the processor is configured to perform a method comprising:
receiving a command to migrate from a first storage system to a second storage system, wherein the first storage system comprises a first primary storage and a first secondary storage, and wherein the second storage system comprises a second primary storage and a second secondary storage;
replicating, in response to receiving the command, data between the first primary storage and the second primary storage;
replicating, in response to receiving the command, data between the first primary storage and the second secondary storage;
in response to full duplex being reached between the first primary storage and both the second primary storage and the second secondary storage:
suspending I/O operations received for executing on the first storage system;
storing the I/O operations in a queue; and
enabling multi-storage volume swapping between the second primary storage and the second secondary storage;
migrating from the first storage system to the second storage system such that new received I/O operations are executed on the second storage system;
resuming I/O operations; and
executing the queued I/O operations on the second storage system.
